(19) United States
(12) Patent Application Publication
(10) Pub. No.: US 2026/0045780 A1
(43) Pub. Date: Feb. 12, 2026

(54) PIPE AND PIPELINE FOR A SUPERCONDUCTING ELECTRICAL CONNECTION

(71) Applicants: NEXANS, Courbevoie (FR); ITP SA, Louveciennes (FR); L'AIR LIQUIDE SOCIETE ANONYME POUR L'ETUDE ET L'EXPLOITATION DES PROCEDES GEORGES CLAUDE, Paris (FR)

(72) Inventors: Nicolas LALLOUET, Courbevoie (FR); Arnaud ALLAIS, Courbevoie (FR); Laurent GERVAISE, Courbevoie (FR); Christian GEERTSEN, Louveciennes (FR); Aurélien DAMOUR, Louveciennes (FR); Pierre BARJHOUX, Sassenage (FR); Pierre CRESPI, Sassenage (FR)

(21) Appl. No.: 19/294,548

(22) Filed: Aug. 8, 2025

(30) Foreign Application Priority Data
Aug. 8, 2024 (FR) FR2408775

(51) Int. Cl. H02G 15/34; H01B 12/04; H01B 12/14; H01B 12/16; H01R 4/68; H02G 9/02

(52) U.S. Cl. CPC H02G 15/34; H01B 12/04; H01B 12/14; H01B 12/16; H01R 4/68; H02G 9/02

(57) ABSTRACT

A pipe for a superconducting electrical connection, forming a unit intended to be connected at its ends for a formation of the superconducting electrical connection, includes a cryostat forming a pipe-in-pipe comprising an inner tube and an outer tube which are coaxial and a thermal insulator occupying the annular area between the outer tube and the inner tube; and a superconducting cable core housed inside the inner tube, the superconducting cable core having, at ambient temperature, an excess length with respect to the length of the cryostat such that, in its superconducting state, the length of the cable core is greater than or equal to the length of the cryostat.

### TECHNICAL FIELD AND TECHNOLOGICAL BACKGROUND

The present invention relates to a pipe for a superconducting electrical connection, in particular a cryogenic pipe, a pipeline comprising it, as well as a method for installing the pipeline, and a superconducting electrical connection comprising the pipeline.

Renewable energy sources are generating interest in view of a transition in energy production. In particular, the generation of electrical energy by offshore wind farms achieves cost parity with other conventional energy production techniques. However, solutions for transporting electrical energy from its place of production offshore to the coasts remain expensive. In particular, for a transport of electrical energy by a conventional resistive electrical cable, it is necessary to transform the electrical energy to high voltage at the offshore wind turbine, to make it less sensitive to losses by Joule effect during transport. However, the transport of electrical energy over long distances generates voltage drops linked to the resistance of the cable, which limits the distance which can be travelled, particularly in alternating current conditions.

Superconducting cables bring several advantages to such connections. First, with dimensions and voltage levels which are substantially equivalent to those of a conventional cable composed of resistive electrical conductors, superconducting cables can transport a much larger electrical current, thanks to a very high admissible current density in their superconducting parts. For example, a so-called “HTS” (high temperature superconductor) superconducting tape typically has a dimension of 3 mm×0.4 mm and can, in its superconducting state, transport currents greater than 250 A. Such an HTS superconducting tape has a current density greater than 200 A/mm² which is much greater than the usual density in resistive conductors of conventional cables, which remains limited to a few amperes per square millimetre. This feature of superconducting cables therefore makes it possible, at equivalent voltages and dimensions, to transport much greater electrical powers than in a conventional high-voltage cable. Typically, a superconducting cable comprises a cryostat surrounding a cable core which comprises the superconducting part and enabling a controlled circulation of a cryogenic fluid.

Another interesting use of superconducting cables for offshore connections consists of using their capacity for transporting high currents to reduce the voltage and increase the compactness of the cable compared with a conventional resistive cable, while preserving an equivalent transport power.

In these applications, superconducting cables have a greater energy transport effectiveness than conventional cables, as the electrical losses along the cable are substantially limited, thanks to the suppression of losses by Joule effect, since this phenomenon is non-existent in the superconducting state. The superconducting character of an electrical connection makes it possible to very substantially reduce the voltage drop over long distances, and therefore to design connections which remain effective over much longer lengths than a conventional resistive cable.

Due to these advantages, and in a more practical way, the use of superconducting cables for the transport of energy from offshore wind farms would therefore make it possible to greatly decrease, or even remove, the needs to transform electrical energy to higher voltages or to convert it to direct current at the offshore substation. However, conventional superconducting cables are not suitable for underwater use over long lengths, as their cryogenic casings are flexible and can withstand neither the stresses linked to a deposition at sea, nor the high pressures existing in the seabed and being exerted on the external casing, nor the high pressures required for the circulation of a cryogenic fluid in the internal casing.

Patent application publication EP 2 615 614 A1 is known, which describes a superconducting electrical connection comprising a pipe formed of an inner tube and an outer tube which are concentric. The central area of the inner tube receives the superconducting cable. The outer and inner tubes comprise bellows to manage thermal contraction during a drop in temperature to reach the superconducting state of the superconducting cable. Furthermore, a camera views a target at one end of the cable; and an actuation device moves the ends of the inner and outer tubes, thanks to the bellows in correspondence with the movement of the target detected by the camera. Managing the thermal contraction of the superconducting cable and of the inner and outer tubes of its cryostat is therefore complex and requires sophisticated active devices. Furthermore, the bellows introduce points of mechanical weakness which are not compatible with the stresses linked to a deposition at sea, and are poorly suitable for the internal pressure stresses in the inner tube linked to the circulation of a cryogenic fluid. These bellows further introduce a high resistance to the flow of the cryogenic fluid. These disadvantages of bellows do not favour the production of superconducting connections over long lengths, as, for economic reasons, these require significant separations between the cooling and pumping stations.

On the other hand, the system described operates only in electrical connections which are short enough, such that the thermal contraction force can be transmitted over the length of the cable to the mobile zones. Beyond a certain length, the specific weight of the cable will prevent its contraction, which introduces a level of stress which is damaging to its operation.

There is therefore a need for a superconducting electrical connection pipe, in particular for an underwater installation, in which the management of the thermal contraction of the superconducting cable is simplified, while maintaining a robustness and a high reliability facing installation, cryogenic fluid circulation, operating and environmental constraints.

### SUMMARY OF THE INVENTION

For this, the invention proposes a pipe for a superconducting electrical connection, forming a unit intended to be connected at its ends for forming the superconducting electrical connection, comprising:
a cryostat forming a pipe-in-pipe (PiP) comprising an inner tube and an outer tube which are coaxial and a thermal insulator occupying the annular area between the outer tube and the inner tube;
a superconducting cable core housed inside the inner tube, the superconducting cable core having, at ambient temperature, an excess length with respect to the length of the cryostat, such that, in its superconducting state, the length of the superconducting cable core is greater than or equal to the length of the cryostat.

Thanks to its excess length at ambient temperature, when the superconducting cable core retracts under the effect of the passage to the critical temperature below which the superconducting state appears, it exerts very little mechanical stress on its junctions with other cable cores or an ending of the superconducting electrical connection. The management of the thermal contraction is therefore obtained by arranging the core cable within the cryostat during the assembly of the pipe, and not using sophisticated active devices. The management of the thermal contraction is therefore simplified with respect to the prior art.

According to an embodiment, the excess length of the cable core is greater than or equal to 0.3% with respect to the length of the cryostat at ambient temperature.

According to an embodiment, the inner tube has a thermal expansion coefficient, less than or equal to 2.10⁻⁶ m/(m·K).

According to a variant, the inner tube is made of an FeNi alloy of between 34 and 38% nickel.

According to an embodiment, the thermal insulator has a Young's modulus in compression, greater than 0.1 MPa, even 0.5 MPa.

According to an embodiment, the thermal insulator is configured to operate at a pressure of between 0.01 mbar and 10 mbar.

According to an embodiment, the pipe for a superconducting electrical connection comprises a plurality of said superconducting cable cores housed inside the inner tube.

According to an embodiment, the pipe for a superconducting electrical connection comprises at least one blocking device fixing a point of the superconducting cable core to the inner tube.

According to a variant, the blocking device further forms a spacer maintaining the point of the superconducting cable core at a distance from the inner tube.

According to a variant, the cable core blocking device is located in the proximity of or at one of the ends of the pipe.

According to a variant, a respective blocking device is located in the proximity, or at each end, of the pipe.

The invention further relates to a pipeline for a superconducting electrical connection, comprising a plurality of pipes according to the invention, the pipes being successively joined at their ends by a respective pipe junction,

said pipe junction comprising:
an electrical junction producing an electrical connection of the superconducting cable cores,
a cryostat junction producing a junction of the inner tubes, a junction of the outer tubes, and a continuity of the thermal insulators.

According to an embodiment, the pipeline comprises a plurality of pipes according to an embodiment, said pipeline being configured, such that a length of cable core between two blocking devices is greater than the distance between the two blocking devices.

The invention also relates to a method for installing a pipeline for a superconducting electrical connection, comprising:
the production of several pipes for a superconducting electrical connection according to the invention;
securing said pipes one after the other by pipe junctions at their ends.

According to an embodiment, the method comprises the production of at least one pipe according to the invention, the securing step comprising the destruction of one of its blocking devices, such that the pipeline comprises one single blocking device at each pipe junction.

According to an embodiment, the method comprises the production of at least one pipe according to the invention, the securing step being configured, such that a superconducting cable core portion comprised between two blocking devices opposite one another on either side of a junction is configured to absorb a thermal contraction.

The invention also relates to a method for installing a pipeline according to the invention, comprising:
winding said pipeline on a drum; then,
the unwinding of said pipeline from the drum, in particular from a boat for a deposition on a seabed.

The invention also relates to a method for installing a superconducting electrical connection, comprising:
the installation, in particular on a seabed, of a first pipeline according to the invention,
the junction at sea, in particular on a boat, of the first pipeline with a second pipeline according to the invention.

According to an embodiment, the method comprises the connection of the pipelines with one or more cooling and/or pumping units for a circulation of a cryogenic fluid.

### BRIEF DESCRIPTION OF THE FIGURES

The description below with reference to the accompanying drawings, given as non-limiting examples, will clearly explain what the invention consists of, and how it can be achieved. In the accompanying figures:

FIG. 1 represents a first example of a pipe for a superconducting electrical connection;

FIG. 2 represents a second example of a pipe for a superconducting electrical connection;

FIG. 3 represents an example of a pipeline for a superconducting electrical connection;

FIG. 4 represents a first example of a superconducting electrical connection;

FIG. 5 represents a second example of a superconducting electrical connection;

FIG. 6 represents a third example of a superconducting electrical connection;

FIG. 7 represents a fourth example of a superconducting electrical connection;

FIG. 8 represents an example of an assembly of a pipeline for a superconducting electrical connection;

FIG. 9 represents a step of an example of installing a superconducting electrical connection;

FIG. 10 represents a step of the example of installing a superconducting electrical connection;

FIG. 11 represents a step of the example of installing a superconducting electrical connection;

FIG. 12 represents a step of the example of installing a superconducting electrical connection;

FIG. 13 represents a step of the example of installing a superconducting electrical connection.

### DETAILED DESCRIPTION

A first example 100 of a pipe for a superconducting electrical connection will be described in relation to FIG. 1.

The pipe 100 comprises a superconducting cable core 105 extending into a cryostat 110. The cryostat 110 forms a pipe-in-pipe (PiP). The cryostat 110 comprises an inner tube 111 and an outer tube 112 which are coaxial. A thermal insulator 113 occupies the annular area between the inner tube 111 and the outer tube 112, in particular to within an insertion clearance. The superconducting cable core 105 is housed inside the inner tube 111.

In particular, the inner tube 111 is at the cryogenic temperature when the pipe is in operation. The inner tube 111 therefore makes it possible to maintain the cryogenic temperature for the superconducting cable core 105. In particular, the thermal insulator 113 ensures a thermal insulation between the inner tube 111 and the outer tube 112, the external surface of which is, in particular, at ambient temperature.

The pipe 100 forms a unit, the ends of which will be connected to form a superconducting electrical connection. In particular, the ends of the pipe 100 are configured to be connected to another, preferably identical, pipe or to an ending of the superconducting electrical connection. In particular, the ends of the superconducting cable core 105, of the inner tube 111, and of the outer tube 112 will be connected to corresponding parts of another, preferably identical, pipe or of an ending of the superconducting electrical connection.

The pipe 100 is particular in that, at ambient temperature, the superconducting cable core 105 has an excess length with respect to the length of the cryostat 110, in particular with respect to the lengths of the inner tube 111 and of the outer tube 112. The excess length is configured such that, in its superconducting state, the superconducting cable core 105 has a length which is greater than or equal to that of the cryostat 110, in particular to the lengths of the inner tube 111 and of the outer tube 112. In particular, the superconducting state considered is that obtained when the tube 111 has reached a stabilised temperature under the effect of a circulation of the cryogenic fluid. In particular, along the longitudinal direction, the cable core 105 has a developed length which is greater than the distance between the two longitudinal ends of the inner tube 111 and the outer tube 112.

During its cooling to reach its superconducting state, the cable core 105 undergoes a contraction. In the absence of means to manage this contraction, this is able to create significant mechanical stresses along the superconducting cable core 105 or at its ends. Thanks to the excess length, the cable core 105 can contract, generating very limited mechanical stresses. For example, the excess length of the cable core 105 is greater than or equal to 0.3% with respect to the length of the cryostat at ambient temperature, which corresponds to a typical contraction of a superconducting cable core during a passage from ambient temperature to critical temperature below which the superconducting state is obtained.

In particular, the superconducting cable core 105 corresponds to the central part of a conventional superconducting cable located inside the cryogenic enclosure. In particular, the superconducting cable core 105 comprises, or consists of, a central superconducting part, a dielectric layer surrounding the superconducting part, and a shroud surrounding the dielectric layer. The shroud can itself be constituted of all or some superconductors.

In particular, the cryostat 110 produces a cryogenic enclosure around the superconducting cable core 105, the inner tube 111 being at cryogenic temperature when the pipe is in operation, i.e. when a cryogenic fluid circulates in the pipe In particular, the cryostat 110 has a thermal conductivity along a radial direction which is less than 5 mW/(m·K), or even less than 2.5 mW/(m·K), which enables a good thermal insulation of the pipe 100. For example, the inner tube 111 is configured to receive a cryogenic fluid which circulates around the superconducting cable core 105 to cool it, in particular, through the dielectric layer of the cable core 105. The cryogenic fluid can be at a temperature of less than 100K, preferably less than 80K. Furthermore, or alternatively, the superconducting part of the cable core 105 can form a hollow tube in which the cryogenic fluid circulates.

The cryostat 110 forms a pipe-in-pipe, i.e. a pipe in which the inner tube 111 and the outer tube 112 are coaxial. In particular, the inner 111 and outer 112 tubes are rigid over their entire length. In particular, the inner 111 and outer 112 tubes have no corrugations and bellows. Preferably, the outer tube 112, respectively the inner tube 111, has a uniform diameter and thickness over its entire length, which enables it to better withstand outer and inner pressures and to have reduced load losses, in particular with respect to corrugated tubes or tubes including bellows.

In particular, the outer tube 112 forms a casing which mechanically protects its contents with respect to the outer environment, in particular against humidity or high ambient pressures or mechanical aggressions. For example, the outer tube 112 is made of a metal alloy, such as a carbon steel. In particular, the outer tube 112 is coated with an anti-corrosion layer. For example, the outer tube 112 has a thickness of between 10 mm and 35 mm; and an outer diameter of between 250 mm and 610 mm.

Preferably, the length of the inner tube 111 remains relatively constant during its cooling to a cryogenic temperature less than the critical temperature of the superconducting cable core. In particular, the management of the thermal contraction at the inner tube 111 is obtained by selecting, for the inner tube 111, a material having a low thermal expansion coefficient from among those suitable for cryogenic temperatures. For example, the inner tube 111 has a thermal expansion coefficient less than or equal to 2.10⁻⁶ m/(m·K), in particular along a longitudinal direction of the inner tube 111. For example, the inner tube 111 is made of a metal alloy, such as an FeNi alloy of between 34 and 38% nickel. In particular, the inner tube 111 is made of Invar®, which is an FeNi alloy containing 36% nickel. In particular, the inner tube 111 has a burst pressure very much greater than that of an inner cryostat enclosure of a usual superconducting cable. In particular, the inner tube 111 withstands a pressure of the cryogenic fluid greater than 50 bar.

For example, for an internal diameter of 200 mm and a thickness of 10 mm, the inner tube 111 can withstand a pressure of the cryogenic fluid of around 200 bar. For example, the inner tube 111 has a thickness of between 5 mm and 18 mm; and an outer diameter of between 100 mm and 360 mm.

In particular, because of their rigidity and their very high mechanical resistance, the inner 111 and outer 112 tubes make it possible to install the pipe on deep ocean floors, using standard offshore pipe deposition methods, for example up to 2000 m. In particular, the inner 111 and outer 112 tubes have smooth surfaces, and in particular, large thicknesses, contrary to the corrugated cryogenic enclosures of conventional superconducting cables. This makes it possible to reduce the hydraulic friction coefficients in the inner tube 111 and to accept a higher pressure of the cryogenic fluid in the inner tube 111. In particular, the internal surface of the inner tube 111 has a roughness of less than 30 μm, even 10 μm, so as to reduce the load loss of a cryogenic fluid circulating in the inner tube 111. Thanks to the resistance to higher pressures of the inner tube 111 and to the reduced load losses in it, the pipe 100 makes it possible to obtain pipelines of a greater length (for example, greater than 50 km) between two cryogenic fluid pumping and/or cooling stations. In certain applications, the installation of expensive intermediate offshore pumping and/or cooling stations is thus avoided.

Thus, in particular, the cryostat 110 accepts high pumping pressures and has a low flow resistance.

Preferably, the thermal insulator 113 is itself resistant to compression, or hardens under stress, so as to withstand compression forces between the inner tube 111 and the outer tube 112, in particular during a winding/unwinding installation phase described below. To this end, the thermal insulator 113 has, for example, a Young's modulus, measured in compression, of greater than 0.1 MPa, even 0.5 MPa. For example, the thermal insulator 113 is made of a silica-based microporous material. In particular, the thermal insulator 113 is configured to enable a centring, in particular to within one insertion clearance, of the inner tube 111 in the outer tube 112 by itself, i.e. without using spacers between the outer tube 112 and the inner tube 111. The external diameter of the thermal insulator 113 can have a clearance with respect to the internal diameter of the outer tube 112 to enable its insertion inside the outer tube 112.

In particular, the thermal insulator 113 is vacuum-sealed during the operation of the pipe 100 in a superconducting electrical connection. Preferably, the thermal insulator 113 is configured to operate at a residual pressure of between 0.01 mbar and 10 mbar. In particular, to this end, the microporous material has pores of between 10 and 100 nm in size.

In particular, the internal diameter of the cryostat 110, in particular of the inner tube 111, makes it possible to receive the excess length of the cable core 105. In particular, the excess length takes the form of ripples, spirals or folds inside the inner tube 111. Thus, the excess length can be simply housed in the cryostat 100.

In particular, a blocking device 120 fixes a point of the cable core 105 to the inner tube 111. In particular, the fixing point of the cable core 105 is immovable with respect to the inner tube 111. The blocking device 120 serves to maintain the cable core 105 in the pipe 100 so as to avoid it disengaging from the pipe 100 during a handling of it. Furthermore, the blocking device 120 enables the mechanical stresses to be taken up during the thermal contraction of the cable core 105. Thus, when the pipe 100 is connected with other identical pipes 100 in a pipeline, the mechanical stresses are distributed along the pipeline during cooling, which facilitates the management of the contraction.

In particular, the blocking device 120 further forms a spacer which maintains the fixing point of the cable core 105 at a distance from the inner tube 111, in particular at a central position located on the axis of the inner tube 111. This makes it possible to locally move the cable core 105 away from the internal wall of the inner tube 111. Furthermore, a contact of the superconducting cable core 105 with the inner tube 111 is avoided during the assembly steps between several pipes 100, 102, described below. Indeed, these assembly steps can comprise welds which could damage the cable core 105.

In particular, the blocking device 120 is located in the proximity of one end of the pipe 100. It is thus easy to position after introducing the cable core 105 into the inner tube 111. The pipe 100 can comprise one single blocking device 120 in the proximity of one of its ends, as for example illustrated in FIG. 1. However, the pipe 100 can comprise a blocking device in the proximity of each end. The blocking device(s) 120 is/are in the proximity of the respective end of the pipe 100, even at the respective end of the pipe 100.

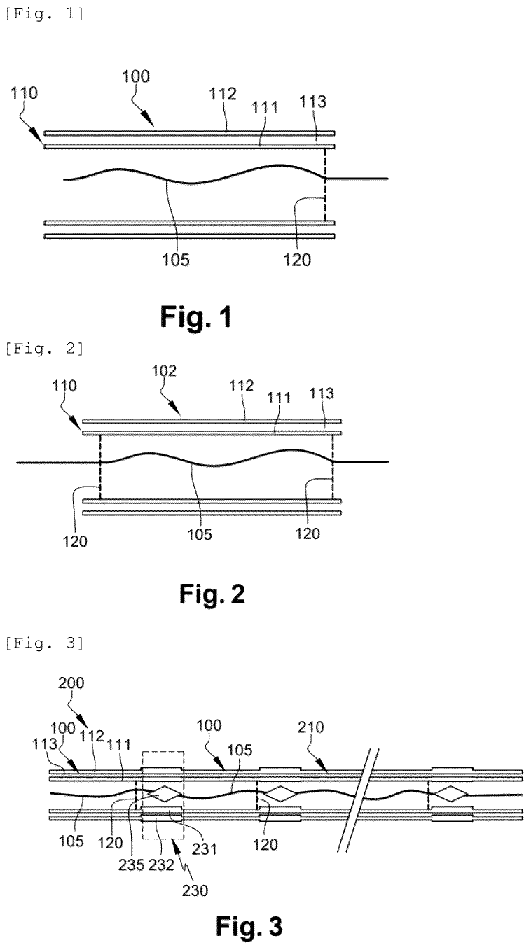

FIG. 2 represents a second example of a pipe 102 identical to the first example of a pipe 100, except that it comprises a blocking device 120 at each end. By having a blocking device 120 at each end, the pipe 102 enables a better maintaining of the cable core 105, in particular during the handling of the pipe 102.

In particular, the pipe 100, 102 has a length of between 500 m and 2 km, preferably between 1 and 1.5 km.

An example of a pipeline 200 integrating a plurality of pipes 100 is illustrated in FIG. 3. The pipes 100 are joined successively at their ends, in particular until they reach a length of around 15 km. In particular, the pipeline 200 is thus wound on a drum to be subsequently installed on an operation site, and in particular, to be joined to one or more other pipelines 200.

A pipe 100 is joined to the adjacent pipe by a pipe junction 230. The junction 230 comprises an electrical junction 235 which produces an electrical connection between the cable cores 105 of the two adjacent pipes 100. In particular, the electrical junction 235 comprises a superconducting cable electrical junction known per se. A cryostat junction comprises a junction 231 of the inner tubes 111, a junction 232 of the outer tubes 112, and a continuity of the thermal insulators 113. In particular, the junctions 231, 232 of the inner 111 and outer 112 tubes are produced by welds. In particular, the junctions 231, 232 have no corrugations and bellows. Preferably, the junctions 231, 232 are configured for a continuous transition between the diameter and thickness of the inner tubes 111, on the one hand, and of the outer tubes 112, on the other hand. In particular, the junctions 231, 232 are configured such that the diameters and thicknesses of the tubes 111, 112 remain uniform between two identical pipes 100.

Thanks to the pipes 100, along the pipeline 200, a length of cable core 105 between two blocking devices 120 is greater than the distance between the two blocking devices 120. Thus, the mechanical stresses due to the thermal contraction of the cable core 105 are distributed along the pipeline 200. In particular, the blocking devices 120 are placed at regular intervals along the pipeline 200.

The blocking devices 120 make it possible, in particular, to block the position of the succession of cable cores 105 during phases of construction, installation, operation and maintenance of the pipeline 200. For example, the blocking devices are installed along the pipeline 200 during their assembly, as will be explained below.

In particular, the cryostat 210 of the pipeline 200 comprises the succession of cryostats 110 of the pipes 100 connected by the cryostat junctions 231, 232. In particular, a cryogenic fluid circulates inside the cryostat 210 of the pipeline 200 to cool the cable core 105. The cryogenic fluid can be cooled, in particular to a temperature less than 100K, preferably less than 80K, pressurised and circulated in a closed loop using one or more dedicated cooling and/or pumping units. The loop is preferably hermetic.

The pipeline 200 can be joined with other pipelines to form a longer pipeline reaching, in particular, several tens of kilometres, for example 60 km.

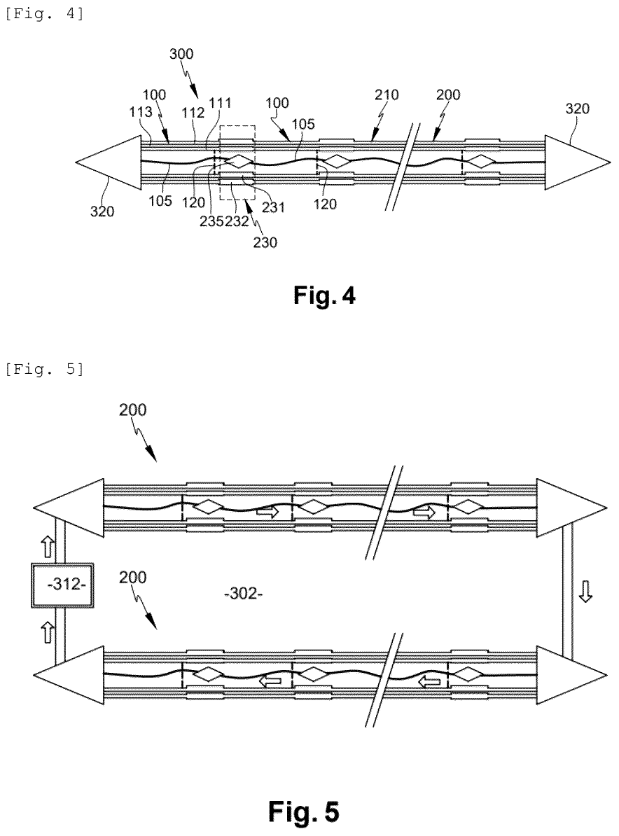

FIG. 4 illustrates a first example of a superconducting electrical connection 300. In particular, the superconducting electrical connection 300 is obtained by connecting several pipelines 200 in series.

In particular, an ending 320 is connected to each end of the electrical connection 300. In particular, the ending 320 has a mechanical functionality of mechanically connecting the inner tube 111 and the outer tube 112 of the cryostat to seal the annular area comprising the thermal insulator 113. The mechanical connection between the inner tube 111 and the outer tube 112 can be made of Invar®, or of another alloy such as stainless steel, or any other composite material resistant to cryogenic temperatures, in particular less than 100K, preferably less than 80K. The ending 320 also has a hydraulic role by enabling the cryogenic fluid to enter and exit the cryostat 210 formed from the succession of cryostats 110 of the pipes 100. The ending 320 also enables a thermal management at the end of the superconducting electrical connection 300 by optimally managing the heat flows between the cryogenic inner environment and the outside at ambient temperature. The ending 320 also ensures an electrical connection between the superconducting cable core 105 at cryogenic temperature and the conventional electrical network operating at ambient temperature.

FIGS. 5 to 7 illustrate other examples of a superconducting electrical connection 302, 303, 304 comprising one or more pipelines 200. In the figures, arrows indicate directions of circulation of the cryogenic fluid. To compensate for an increase in the temperature of the cryogenic fluid or a drop in its circulation pressure, one or more cooling and/or pumping units 312, 314 can be installed at the ends of or along the superconducting electrical connection 302, 303, 304.

The second example 302 of a superconducting electrical connection illustrated in FIG. 5 is a direct current connection comprising two pipelines 200, one including the part of a superconducting cable core constituting the positive pole, the other including the part of a superconducting cable core constituting the negative pole. The superconducting electrical connection 302 comprises, in particular, a cooling and/or pumping unit 312 at one of its ends. The direct current superconducting electrical connection 302 could be produced differently.

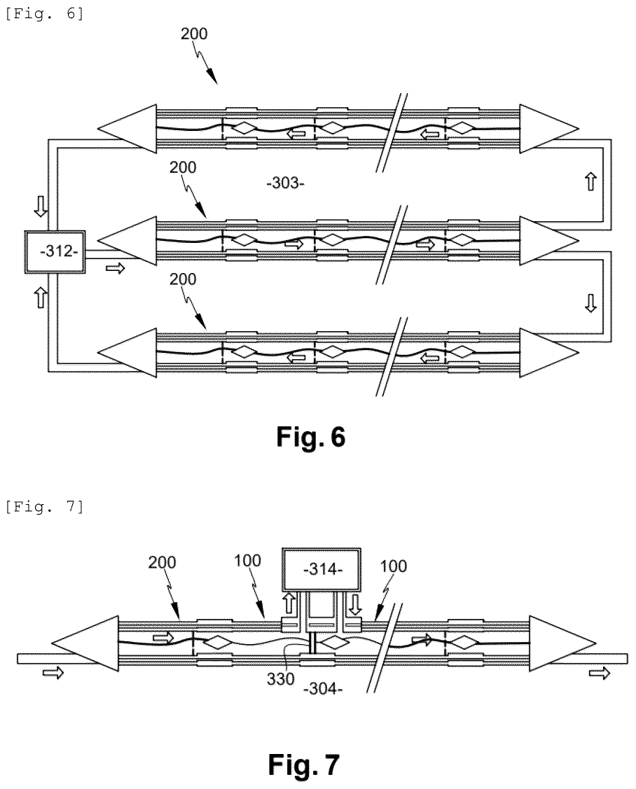

The third example 303 of a superconducting electrical connection illustrated in FIG. 6 is an alternating current three-phase connection, comprising three pipelines 200, each forming an electrical phase. The superconducting electrical connection 303 comprises, in particular, a cooling and/or pumping unit 312 at one of its ends. The three-phase alternating current superconducting electrical connection 303 could be produced differently.

The first example 300, the second example 302 and the third example 303 of a superconducting electrical connection can comprise an intermediate cooling and/or pumping unit 314, as illustrated, in particular, in FIG. 7. The fourth example 304 of a superconducting electrical connection illustrated in FIG. 7 comprises an intermediate cooling and/or pumping station 314, but it could comprise several along the connection 304, for example, regularly distributed for a uniform cooling and/or pumping of the cryogenic fluid. In particular, the intermediate cooling and/or pumping unit 314 is located at a cryostat junction between two pipes 100. The superconducting electrical connection 304 can thus comprise a wall 330 diverting the cryogenic fluid, or most of it, to the intermediate cooling and/or pumping unit 314, where it will be cooled and/or pressurised again to be reinjected into the superconducting electrical connection 304 after the wall 330.

The cooling and/or pumping units 312, 314 can each comprise a pumping unit. This makes it possible to deliver the cryogenic fluid with a high pressure to facilitate its good circulation in the superconducting electrical connection 300, 302, 303, 304 or to compensate for the load loss of the fluid after its circulation over kilometric distances. For example, the cryogenic fluid is liquid nitrogen, in particular, at a temperature of around −200°C., or liquid hydrogen, or any other cryogenic fluid or cryogenic fluid mixture suitable for cooling the cable core 105 below its critical operating temperature.

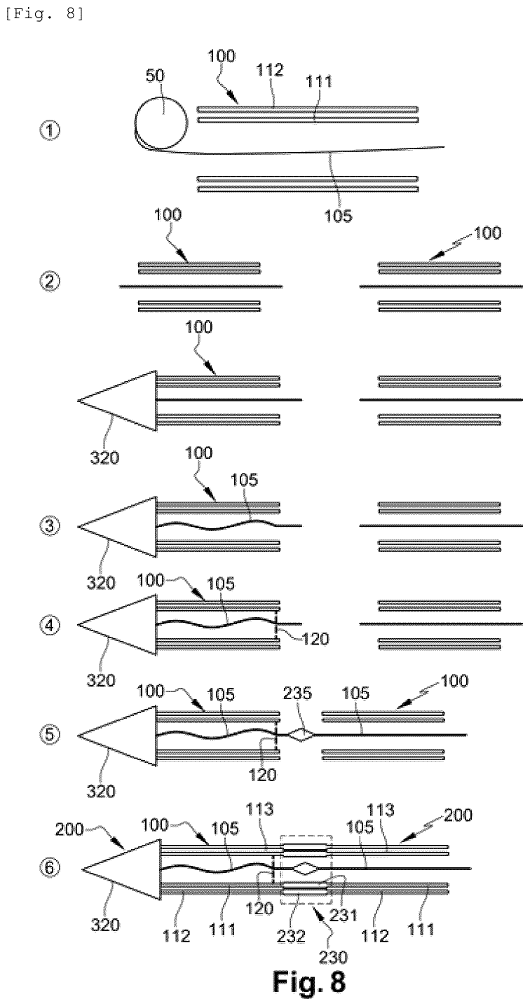

FIG. 8 represents an example of a method for manufacturing an example of a pipeline 200. The method comprises the production of several pipes 100 and the securing of the pipes 100 one after the other at their ends.

In a first step, a pipe 100 is prepared by pulling a cable core 105 into the inner tube 111 of the pipe 100. In particular, the superconducting cable core 105 is unwound from a spool 50 to reach a length comprising the excess length. This step is carried out at ambient temperature.

In step 2, at least two pipes 100 thus formed are ready to be connected together to form the pipeline. Other pipes necessary for the formation of the pipeline can produced at the same time, or can be progressively produced in parallel with the steps described below.

In step 3, an ending 320 or the end of another pipe 100 is connected to one end of a first pipe 100.

In step 4, the cable core 105 is handled inside the first pipe 100 to house the excess length there. For example, the cable core 105 is pushed back inside the first pipe 100 to house the excess length there.

In step 5, the blocking device 120 is positioned in the inner tube 111.

In step 6, an electrical junction 235 is produced between the cable cores 105 of the first pipe 100 and the adjacent pipe 100.

In step 7, the cryostat junction 230 is produced, by connecting the ends of the inner tubes 111 by a junction 231; by connecting the ends of the outer tubes 112 by a junction 232; and by connecting the thermal insulators 113 to ensure continuity of the thermal insulation. For example, the connections between the tubes 111, 112 can be produced by welding.

The method for manufacturing the pipeline 200 illustrated in FIG. 8 could be different. For example, the pipeline 200 could be obtained with a plurality of pipes 102 according to the second example illustrated in FIG. 2.

In particular, steps 4 and 5 are thus carried out before step 3. The pipes 102 are formed, provided with their respective blocking devices 120 at their ends.

In step 3, at a first end of the pipe 102, the blocking device 120 is destroyed. By “destruction”, this means the disabling of the blocking device 120, i.e. the stopping of its function of blocking the superconducting cable core 105. The inactive blocking device 120 can remain partially or totally in the inner tube 111. Then, the ending 320 is connected to the first end of the pipe 102.

Furthermore, before step 7 of producing the cryostat junction, the blocking device 120 of the adjacent pipe 102 which is located opposite the first pipe 102 is destroyed. At the end of the method, a pipeline 200 such as illustrated in step 7 of FIG. 8 is thus obtained, which comprises one single blocking device 120 at each pipe junction 230. By removing one of the blocking devices 120 adjacent to the pipe junction 230, the necessity to manage the contraction of the cable core between the two blocking devices 120 is avoided.

Alternatively, the blocking devices 120 of the first pipe 102 and of the adjacent pipe 102 could be preserved. However, it would thus be necessary to manage the contraction of the cable core 105 between the ending 320 and the blocking device 120 of the first pipe 102 closest to the ending 320, and the contraction of the cable core 105 between the blocking devices 120 located on either side of the pipe junction 230. For example, the contraction could be managed by an excess length between the ending 320 and the blocking device 120 of the first pipe 102 closest to the ending 320 or an excess length between the blocking devices 120 located on either side of the pipe junction 230. The contraction can also be managed by a sliding or flexible electrical junction.

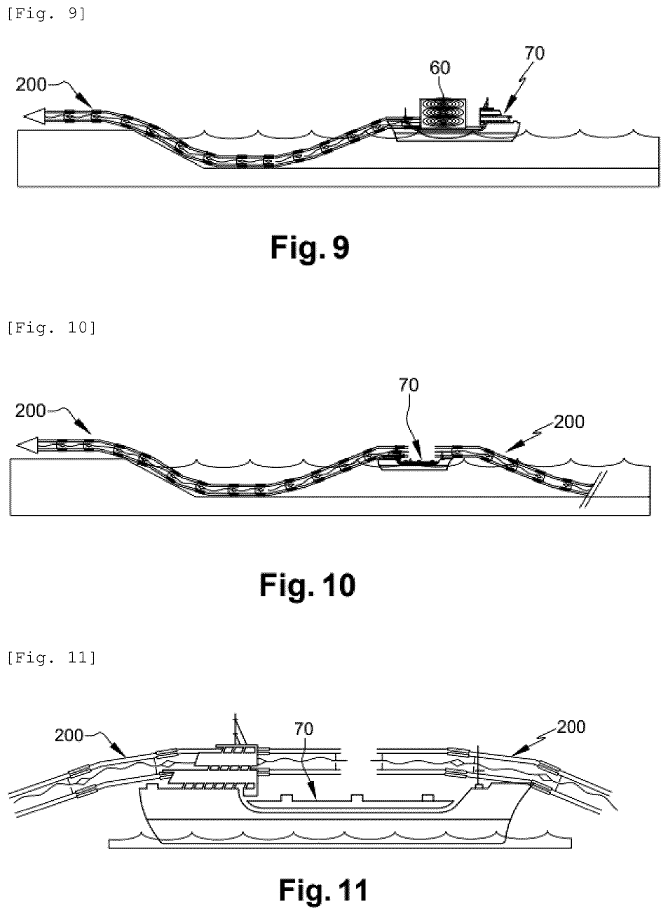

The pipeline 200 can then be installed at its operation site, in particular by a “wound/unwound” method known per se for rigid pipelines. In particular, the pipeline 200 is wound on a drum 60, also called a “turntable” in the field of underwater cable installations. Then, the pipeline 200 is unwound from the drum 60, in particular from a boat 70 for deposition on a seabed, as for example illustrated in FIG. 9. The pipeline 200 can be installed differently, for example, by pulling from the coast.

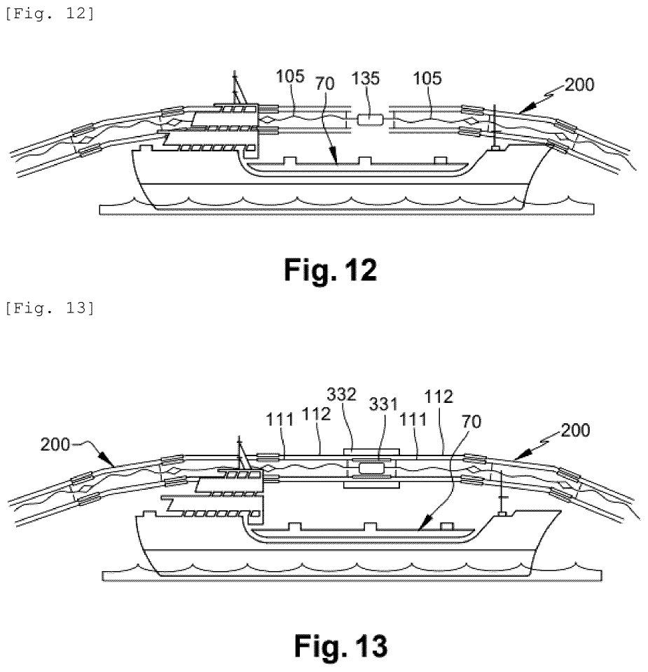

Once installed, a first pipeline 200 can be connected on site, in particular offshore, with a second pipeline 200 to form a superconducting electrical connection, as for example illustrated in FIGS. 10 to 13.

The second pipeline 200 can already be laid on its operation site, or also wound on a drum 60, in particular on the boat 70. In particular, one end of the first pipeline 200 and one end of the second pipeline 200 are placed opposite one another on the boat 70, as illustrated in particular in FIGS. 10 and 11.

Then, the junction of the two pipelines 200 can be done offshore on the boat 70. In particular, an electrical junction 335 is produced between the two cable cores 105. This junction 335 can be different from or identical to the junction 235 described above. Then, a junction 331 is produced between the inner tubes 111; and a junction 332 is produced between the outer tubes 112. The junctions 331, 332 can be identical to or different from the junctions 231, 232 between the pipes described above. The thermal insulators are also connected, identically or differently from what has been described in relation to the pipe junctions 230.

For example, to reduce the offshore production time of a junction between two pipelines 200, the electrical junction 335 and the junctions of the tubes 331 and 332 can be prepared ashore during the preparation and the installation of permanent and/or temporary connection components. Then, the final assembly of the electrical junction 335 between the two cable cores 105, junctions 331 and 332 between the inner tubes 111 and between the outer tubes 112 and the continuity of the thermal insulation are done on the boat offshore.

In particular, when the second pipeline is unwound on a drum 60, the ends of the first pipeline and of the second pipeline are joined. Then, the second pipeline is installed similarly to the first pipeline, for example, by the “wound/unwound”method.

In particular, the pipe 100, 102 comprises one or more cable cores 105. Thus, the pipeline 200 can comprise several cable cores installed in one same cryostat.

The superconducting electrical connection 300, 302, 303, 304 can comprise one or more pipelines 200.

Once installed, the superconducting electrical connection 300, 302, 303, 304 can connect one or more offshore wind farms to each other or to the coast. For example, wind farms are at a distance from the coast of between 50 and 100 km. In particular, the superconducting electrical connection 300, 302, 303, 304 can serve to supply electrical power to offshore platforms from ashore electrical generation. The superconducting electrical connection 300 can produce an underwater electrical interconnecting connection for other applications over short or long distances. The superconducting electrical connection 300, 302, 303, 304 can also be used for an ashore electrical connection. It can thus be buried, overhead or installed in a directional borehole.

In practice, the notions of concentricity and of coaxiality can be approximate, as the tubes 111, 112 may not be perfectly straight or round and/or be mounted with an insertion clearance. The same applies to the central position of the cable core 105.

Preferably, the blocking device 120 is open to enable a cryogenic fluid circulating in the inner tube 111 to pass, while limiting load losses in the inner tube. For example, the blocking device has an annular shape with large openings allowing the fluid to pass or the blocking device comprises fins extending radially between the superconducting cable core 105 to the inner tube 111.

1. A pipe for a superconducting electrical connection forming a unit intended to be connected at its ends for a formation of the superconducting electrical connection, comprising:
a cryostat forming a pipe-in-pipe comprising an inner tube and an outer tube, which are rigid and coaxial with each other, and a thermal insulator occupying the annular area between the outer tube and the inner tube, the thermal insulator being configured to enable a centring, to within an insertion clearance, of the inner tube in the outer tube;
a superconducting cable core housed inside the inner tube, the superconducting cable core having, at ambient temperature, an excess length with respect to the length of the cryostat such that, in its superconducting state, the length of the cable core is greater than or equal to the length of the cryostat.

2. The pipe for a superconducting electrical connection according to claim 1, wherein the excess length of the cable core is greater than or equal to 0.3% with respect to the length of the cryostat at ambient temperature.

3. The pipe for a superconducting electrical connection according to claim 1, wherein the inner tube has a thermal expansion coefficient, less than or equal to 2.10-6 m/(m·K).

4. The pipe for a superconducting electrical connection according to claim 3, wherein the inner tube is made of an FeNi alloy of between 34 and 38% nickel.

5. The pipe for a superconducting electrical connection according to claim 1, wherein the thermal insulator has a Young's modulus in compression, greater than 0.1 MPa, even 0.5 MPa.

6. The pipe for a superconducting electrical connection according to claim 1, wherein the thermal insulator is configured to operate at a pressure of between 0.01 mbar and 10 mbar.

7. The pipe for a superconducting electrical connection according to claim 1, comprising a plurality of said superconducting cable cores housed inside the inner tube.

8. The pipe for a superconducting electrical connection according to claim 1, comprising at least one blocking device fixing a point of the superconducting cable core to the inner tube to take up mechanical stresses during the contraction of the superconducting cable core.

9. The pipe for a superconducting electrical connection according to claim 8, wherein the blocking device further forms a spacer maintaining the point of the superconducting cable core at a distance from the inner tube.

10. The pipe for a superconducting electrical connection according to claim 8, wherein the blocking device of the cable core is located in the proximity of, or at one of the ends of the pipe.

11. The pipe for a superconducting electrical connection according to claim 10, wherein a respective blocking device is located in the proximity of, or at each end of the pipe.

12. The pipe for a superconducting electrical connection according to claim 8, wherein the blocking device is open to enable a cryogenic fluid circulating in the inner tube to pass, while limiting load losses in the inner tube.

13. The pipe for a superconducting electrical connection according to claim 8, wherein the blocking device is arranged to be able to be disabled.

14. The pipe for a superconducting electrical connection according to claim 1, wherein the inner tube has an internal surface having a roughness of less than 30 μm, even 10 μm, so as to reduce the load loss of a cryogenic fluid circulating in the inner tube.

15. A pipeline for a superconducting electrical connection comprising a plurality of pipes according to claim 1, the pipes being successively joined at their ends by a respective conduit junction,
said conduit junction comprising:
an electrical junction producing an electrical connection of the superconducting cable cores,
a cryostat junction producing a junction of the inner tubes a junction of the outer tubes and a continuity of the thermal insulators

16. The pipeline for a superconducting electrical connection according to claim 15, comprising a plurality of pipes comprising at least one blocking device fixing a point of the superconducting cable core to the inner tube to take up mechanical stresses during the contraction of the superconducting cable core, said pipeline being configured, such that a cable core length between two blocking devices is greater than the distance between the two blocking devices.

17. A method for installing a pipeline for a superconducting electrical connection, comprising:
producing several pipes for superconducting electrical connections according to claim 1;
said pipes one after the other by pipe junctions at their ends.

18. The method according to the claim 17, comprising
producing at least one pipe comprising at least one blocking device fixing a point of the superconducting cable core to the inner tube to take up mechanical stresses during the contraction of the superconducting cable core, wherein the blocking device of the cable core is located in the proximity of, or at one of the ends of the pipe, wherein a respective blocking device is located in the proximity of, or at each end of the pipe, and
the securing step comprising the destruction of one of its blocking devices, such that the pipeline comprises one single blocking device at each pipe junction.

19. The method according to claim 17, comprising
producing at least one pipe comprising at least one blocking device fixing a point of the superconducting cable core to the inner tube to take up mechanical stresses during the contraction of the superconducting cable core, wherein the blocking device of the cable core is located in the proximity of, or at one of the ends of the pipe, wherein a respective blocking device is located in the proximity of, or at each end of the pipe, and
the securing step being configured, such that a portion of a superconducting cable core comprised between two blocking devices opposite one another on either side of a pipe junction is configured to absorb a thermal contraction.

20. A method for installing a pipeline according to claim 12 comprising:
winding said pipeline on a drum; then,
said pipeline from the drum from a boat for deposition on a seabed.

21. A method for installing a superconducting electrical connection, comprising:
installing, on a seabed, a first pipeline according to claim 12;
performing junction offshore, on a boat, of the first pipeline with a second pipeline according to claim 12.

22. The method according to claim 17, comprising the connection of the pipelines with one or more cooling and/or pumping units for a circulation of a cryogenic fluid.
